(19) United States
(12) Patent Application Publication
(10) Pub. No.: US 2024/0260582 A1
(43) Pub. Date: Aug. 8, 2024

(54) PROCESS FOR THE PRODUCTION OF HYBRID ANTIMICROBIAL AND ANTIVIRAL AGENT OF COPPER NANOPARTICLES AND ACTIVE ORGANIC COMPOUNDS, ANTIMICROBIAL AND ANTIVIRAL AGENT THUS PRODUCED AND, USE OF ANTIMICROBIAL AND ANTIVIRAL AGENT

(71) Applicants: Instituto de Pesquisas Tecnológicas do Estado de São Paulo S/A - IPT, São Paulo (BR); Cecil S/A Laminação de Metais, Itapevi (BR)

(72) Inventors: Pedro PAULO NORONHA SILVA DE JESUS, São Paulo (BR); Rúbia RODRIGUES CONTI, São Paulo (BR); Natália NETO PEREIRA CERIZE, São Paulo (BR); Adriano MARIM DE OLIVEIRA, São Paulo (BR); Maria ANTONIETTA CERVETTO, Itapevi (BR)

(73) Assignees: Instituto de Pesquisas Tecnológicas do Estado de São Paulo S/A - IPT, São Paulo (BR); Cecil S/A Laminação de Metais, Itapevi (BR)

(21) Appl. No.: 17/926,176

(22) PCT Filed: Dec. 21, 2021
(86) PCT No.: PCT/BR2021/050571

§ 371 Date: Nov. 18, 2022

(30) Foreign Application Priority Data
Dec. 22, 2020 (BR) BR102020026481-8

(51) Int. Cl. A01N 59/20; A01N 25/34; A01P 1/00

(52) U.S. Cl. CPC A01N 59/20; A01N 25/34; A01P 1/00

(57) ABSTRACT

This invention is related to a product consisting of metallic copper nanoparticles with antimicrobial and antiviral activity coated with a polysaccharide biopolymer, or a cationic surfactant for application as an antimicrobial and antiviral agent, i.e., with biocidal action by contact surface effect, which can be used in the agricultural, veterinary, hospital, and other environments.

### RELATED APPLICATIONS

This application is a National Phase of PCT Patent Application No. PCT/BR2021/050571 having International filing date of Dec. 21, 2021, which claims the benefit of priority of Brazil Patent Application No. BR102020026481-8 filed on 22 Dec. 2020. The contents of the above applications are all incorporated by reference as if fully set forth herein in their entirety.

### FIELD AND BACKGROUND OF THE INVENTION

The present invention is related to the production of an antimicrobial and antiviral agent, that is, a compound that has a biocide activity, killing microorganisms and viruses or preventing their development and proliferation. This invention suggests a process for the production of an antimicrobial and antiviral agent based on copper nanoparticles, which can be incorporated as an additive in resins, paints, paper, fabrics, wood, polymeric or dispersed materials in sanitizing products, such as detergents, gel alcohol, disinfectant or tissue softening, or be applied in strategic environments requiring lower contamination rates, such as hospital, agricultural and livestock and veterinary areas, as well as public and indoor public transport environments.

The concept of antimicrobial and antiviral activity is defined as the property of a compound in killing or inhibiting the growth of a microorganism and virus, respectively. Metallic copper may act as non-selective antimicrobial and antiviral agent to kill or contain the proliferation of microorganisms and viruses (VINCENT, et al, 2017). To optimize its use, nanotechnology is used, which can provide or increase some characteristics of materials by decreasing their size to the nanometric scale (PRADEEP, 2007).

The production of nanoparticles can occur via the bottom-up or top-down method, i.e. by the controlled increase in particle size, usually by the chemical route or by the decrease in particle size by the chemical or physical route, respectively, where the chemical route normally is less energy expensive than the physical route (SERGEEV, 2004). Some metals, such as copper, need to be kept in a stable structure to remain dispersed in a liquid. In this way, a stabilizing agent should be used to provide maintenance of the structure formed by a chemical reaction (PRADEEP, 2007).

For the synthesis of metal nanoparticles by chemical route, starting on conjugated salt of the metal which is soluble in aqueous medium. Thus, from a reduction oxide reaction, the metal is produced in its reduced state, unstable due to its large surface area when on a nanometric scale. For particle stabilization, polymers or surfactant agents may be used, which will fill the particles and disperse it in the liquid medium (USMAN, et al, 2013; ZHONG, et al, 2013). As a water-soluble polysaccharide biopolymer, the solvent used in the synthesis process becomes an alternative for the stabilization of nanostructures (USMAN, et al, 2012; ZHONG, et al, 2013). Furthermore, similarly, as a water-soluble cation surfactant, it also becomes another alternative for the stabilization of nanostructures (ADLHART, et al, 2018; BEYTH, et al, 2015).

The polysaccharide biopolymer on the surface of metal nanoparticles modifies the type of interaction with microorganisms, as it presents characteristics of its main food source (PRADEEP, 2007; SERGEEV, 2004; TORTORA, FUNKE, CASE, 2012). From this mask in the characteristics of metal nanoparticles, for example the biocide action of metallic copper, microorganisms can interact and even perform their ingestion, causing cell death (USMAN, et al, 2013; ZHONG, et al, 2013).

The cationic surfactant stabilizes the metal nanoparticles by a surface effect by forming a micellar structure in aqueous medium, where the hydrophobic chain is inside the micellar, coating the metallic material, and the positive-charged end is outside the micellar, interacting with the aqueous medium (ATKINS, JONES, 2012; PRADEEP, 2007; SERGEEV, 2004). From their detergent characteristics, surfactants have a biocide effect against some microorganisms, modifying the stability and porosity of the membrane structure, causing cell death (TORTORA, FUNKE, CASE, 2012).

The polymeric or surfactant structure on the surface of the nanoparticles allows the incorporation of metals into other polymeric materials or compatible resins (ADLHART, et al, 2018; BEYTH, et al, 2015; PHAM, et al, 2011). However, features that stabilize and protect nanoparticles while the structure is dry are necessary, as well as allowing access to microorganisms and action against viruses.

For the metal copper-based nano structures to grant an antimicrobial and surface antiviral effect on an ink, varnish, or even a polymer, the material should be dried, i.e. the water from the system should be removed by evaporation (FAZENDA, et al, 2009; USMAN, et al, 2013; ZHONG, et al, 2013). For the incorporation of metal copper-based nanostructures into a paint, the water can be removed by simple evaporation, forming a thin film (FAZENDA, et al, 2009). In addition, the drying of the suspension of metal copper-based nanostructures can be performed by spray drying, forming dry particles between 300 and 5000 nm, of the developed nanostructures, and allowing their incorporation into compatible polymers (ZHONG, et al, 2015).

Thus, based on publications in the literature (APPLEROT, et al, 2012; AZAM, et al, 2012; DEPNER, et al, 2015; ROY, et al, 2017; TAMAYO, et al, 2016; USMAN, et al, 2013; VINCENT, HARTEMANN, DEUSTCH, 2016; ZHONG, et al, 2013; ZHONG, et al, 2015), it is feasible to use nanostructures in strategic areas, for example in agriculture, veterinary and hospital areas.

However, in the studies mentioned above, no information is provided on systematic studies of process parameters, and the method of reagent feeding, ratio of the molar concentration between the copper precursor salt and the reducing agent, stirring speed, heating temperature, pH variation, concentration of antioxidant agent and copper concentration, controlling the morphology and stability of copper nanoparticles produced in a batch system with an atmosphere controlled with inert gas. Furthermore, only the study by Usman and collaborators (2013) used ascorbic acid as an antioxidant agent as an oxidative protector of metal nanoparticles, but without a detailed study of the concentration used.

Thus, there are no reports in the state of the arts that anticipate a process of production of an antimicrobial agent based on copper nanoparticles and active organic compounds, with characteristics superior to the materials used and their use as additive in resins, paints, paper, fabrics, wood, polymeric or dispersed materials in sanitizing products, or even their application in strategic environments requiring lower contamination rates, such as hospital, agriculture and livestock and veterinary areas, as well as public and indoor public transport environments

### SUMMARY OF THE INVENTION

The present invention is related to the production of an antimicrobial and hybrid antiviral agent of copper nanoparticles and active organic compounds, comprising metallic copper with antimicrobial and antiviral activity.

The first goal of the present invention is to develop a processing route for the production of hybrid antimicrobial and antiviral agent of copper nanoparticles and active organic compounds that have characteristics higher than the materials currently used.

A second goal of this invention is to highlight the applicability and efficiency of hybrid formulations of copper nanoparticles and active organic compounds as antimicrobial and antiviral agents

The formulation applications involve action such as antimicrobial and antiviral agents, that is, with biocide action by contact surface effect, and can be used in different sectors that require contamination control.

In order to achieve the goals described above, the present invention proposes the synthesis of metal copper nanoparticles by co-precipitation, by the method of chemical reduction in the presence of the polysaccharide biopolymer or cationic surfactant, in a batch-fed system. Next, the suspension generated in the synthesis is then dried by simple evaporation or by the spray drying technique. The mass proportion of metallic copper may be regulated by the addition of polymer to the suspension before drying.

The process herein proposed allows the production of metal copper-base nanostructures in a batch-fed system with control of process parameters, such as the method of reagent feeding, ratio of the molar contraction between the copper precursor salt and the reducing agent, stirring speed, heating temperature, pH variation, concentration of antioxidant agent and copper concentration, controlling the morphology and stability of copper nanoparticles produced in a batch system with atmosphere optionally controlled with inert gas.

The inert atmosphere removes the presence of oxygen gas from the atmosphere of the synthesis system, avoiding the early oxidation of metal copper nanoparticles, with the formation of cupric oxides (CuO) and cuprous (Cu₂O). The variation of the method and sequencing of the reagent feed makes possible to use different coating agents of the metal copper nanoparticles produced.

As for the concentration of the compounds used in the process, the use of a higher molar concentration of reducing agent in the presence of the concentration of the precursor copper substrate for the chemical reduction reaction promotes the chemical balance toward metallic copper, avoiding the reoxidation of metal nanoparticles in the reactional medium. Higher concentrations of antioxidant agent allow the stabilization of the material due to the non-degradation of copper nanoparticles by oxidative reactions, while a higher concentration of copper increases the percentage of solids in the material, reducing the amount of water in the system.

Advantageous, the use of higher stirring speeds promotes higher shear conditions, reducing the size of metal copper particles. Higher temperatures promote the increase in the solubility of ionic copper in the reactional medium, forming more nuclei during the time of the chemical reduction reaction, which decreases the size of metallic copper particles. PH variation allows stabilization of copper nanoparticles due to the lower presence of ions available in the aqueous medium that can interact with the metallic material.

By incorporating it as an additive in resins, paints, paper, fabrics, wood, polymeric or dispersed materials in sanitizing products such as: detergents, gel alcohol, disinfectants or tissue softeners, nanostructures can be applied in strategic environments that require lower contamination rates, such as hospital, public environments, public transport interiors, agriculture and livestock and veterinary.

Copper nanoparticles are responsible for the antimicrobial and antiviral effect, while the coating agent involves particles to help disperse nanostructures in aqueous medium and to ensure metal compatibility with microorganisms and viruses, allowing the interactions of structures with cells by surface effect.

These goals and other advantages of this invention will be more evident from the description below and the attached figures.

### BRIEF DESCRIPTION OF THE SEVERAL VIEWS OF THE DRAWINGS

The detailed description below refers to the attached figures.

FIG. 1 shows the distribution of sizes of the mean hydrodynamic diameter of the nanostructures based on metallic copper and polymer of chitosan polysaccharide.

FIG. 2 shows the transmission electronic microscopy of the metal copper-based nanostructures and polymer of chitosan polysaccharide with magnification of 150 thousand times.

FIG. 3 shows the transmission electronic microscopy of the metal copper-based nanostructures and polymer of chitosan polysaccharide with magnification of 50 thousand times.

FIG. 4 shows the comparison of FTIR spectrograms of the metallic coper-base nanostructures and polymer of chitosan polysaccharide.

FIG. 5 shows the spectrograms of scan in UV-Vis of the nanostructures based on metallic copper and polymer of chitosan polysaccharide.

FIG. 6 shows the distribution of sizes of the mean hydrodynamic diameter of the nanostructures based on metallic copper and polymer of carboximetylcelulosis polysaccharide.

FIG. 7 shows the distribution of sizes of the mean hydrodynamic diameter of the metallic copper-base nanostructures and polymer of acacia gum polysaccharide.

FIG. 8 shows the distribution of sizes of the mean hydrodynamic diameter of the metallic copper base nanostructures and polymer of cetylpyridine polysaccharide.

FIG. 9 shows the distribution of sizes of the mean hydrodynamic diameter of the metallic copper base nanostructures and monolaurate surfactant of ethoxylate Sorbitano 80

FIG. 10 shows the distribution of sizes of the mean hydrodynamic diameter of the nanostructures based on metallic copper and amidopropyl betaine coco surfactant.

### DESCRIPTION OF SPECIFIC EMBODIMENTS OF THE INVENTION

The present invention refers to the production of hybrid antimicrobial and antiviral agent of copper nanoparticles and active organic compounds, comprising a nano-structured system composed of metal copper nanoparticles coated with a polysaccharide biopolymer or a cationic surfactant.

In addition, at least 90% of the product of metallic copper based nanoparticles coated with the polysaccharide biopolymer of the antimicrobial and antiviral agent prepared by the claimed process have particle size below 560 nm.

In general, the process for the production of an antimicrobial agent and hybrid antiviral copper nanoparticles, comprising the synthesis of metal nanoparticles by the chemical route, starting from a conjugated salt of the metal which is soluble in aqueous medium, according to the present invention, comprises the following stages:
a) add, in a reactor:
   (i) A precursor solution of metallic copper in water with a concentration ranging from approximately 0.1 mmol/L to approximately 20 mol/L;
   (ii) a coating agent selected from a polysaccharide biopolymer or cationic surfactant, in concentration, ranging from approximately 0.1% to approximately 25.0% (m/m); and
   (iii) A solution of oxidizing agent in water with a concentration between approximately 0.1 mmol/L and approximately 10.0 mol/L;
b) complete the reactor volume with water to fill half the reactor volume, except for the volume of the reducing agent to be added;
c) Seal the system, keeping the temperature control between approximately 0° C. and approximately 100° C.;
d) optionally, add inert gas to the reactor;
e) Stir the mixture obtained with a speed between approximately 250 rpm and approximately 1500 rpm;
f) After temperature stabilization, add solution of reducing agent at constant flow between approximately 0.1 mL/hour and approximately 10.0 L/hour.

In the scope of this invention, the polysaccharide biopolymer is selected from the group consisting of chitosan, carboxymethylcellulose and acacia gum, or mixtures thereof.

According to the present invention, cationic surfactant is selected from the group consisting of cetylpyridinium chloride, Sorbitano monolaurate ethoxylated 80 and cocoamidoppropyl betaine, or mixtures thereof.

Initially, a synthesis of metallic copper is performed in a typical experiment of chemical reduction co-precipitation. In this procedure, a precursor of metallic copper is solubilized in water with concentration ranging from approximately 0.1 mmol/L to approximately 20 mol/L, preferably approximately 1 mmol/L to approximately 10 mol/L, more preferably approximately 100 mmol/L.

According to this invention, as a precursor of copper, selected compounds may be used among copper acetate, copper carbonate, copper chloride, copper hydroxide, copper iodide, copper nitrate, copper oxide (I), copper oxide (II), copper sulphate, copper sulfide (I), copper sulfide (II) and mixtures thereof. The copper precursor is preferably copper sulphate (CuSO₄·5H₂O).

Separately, a coating solution containing the polysaccharide biopolymer is prepared (from approximately 0.1% to approximately 2.5% (m/m), preferably approximately 1.0% (m/m), of chitosan dissolved in acetic acid solution in water with a concentration between preferably approximately 0.1 mol/L and approximately 5.0 mol/L; either carboxymethylcellulose dissolved in water in the mass proportion between approximately 0.1% and approximately 10.0%, preferably 5.0%; or acacia dissolved in water in concentration between approximately 0.1% and approximately 25.0%, preferably approximately 10.0%; or mixtures thereof).

Also separately, a solution of each surfactant is prepared by dissolving the cationic surfactant (cetylpyridinium chloride in deionized water in mass proportion between approximately 0.05% and approximately 20.0%, preferably approximately 5.0%; Either by dissolving Sorbitano ethoxylated monolaurate 80 in water in mass proportion between approximately 0.05% and approximately 20.0%, preferably approximately 5.0%, or by dissolving amidopropyl betaine coconut in water in mass proportion between approximately 0.05% and approximately 20.0%, preferably approximately 3.5%; or mixtures thereof).

Furthermore, an ascorbic acid solution is prepared in deionized water with a concentration between approximately 0.1 mmol/L and approximately 10.0 mol/L, preferably approximately 50 mmol/L, to be used as an antioxidant agent; and an aqueous solution of NaBH₄ in deionized water with a concentration between approximately 0.1 mmol/L and approximately 10.0 mol/L, preferably approximately 100 mmol/L, to be used as reducing agent.

Then, in a reactor with temperature control system, the solution of the copper precursor, the coating agent solution, can be a polysaccharide biopolymer or a cationic surfactant, and the ascorbic acid solution, complete with water in order to fill half the reactor volume, except for the volume of the reducing agent to be added, at component concentrations, respectively: preferably approximately 10 mmol/L of copper precursor; mass proportion of coating agent varying from approximately 0.1% to approximately 2.5% in relation to the components of the medium and ascorbic acid in metabolic concentration ranging from approximately 1 μmol/L to approximately 25 μmol/L. Therefore, the system is sealed, maintaining the temperature control between approximately 0° C. and approximately 100° C., particularly between approximately 10° C. and approximately 60° C., preferably approximately 25° C.

Optionally, the system is inert with the insertion of inert gas, selected from helium, argon or nitrogen, preferably nitrogen, at constant flow and the liquid is constantly stirred in the reactor with an impeller, preferably a propeller type, composed of or coated with inert material to the reaction. Stirring is performed at a speed between approximately 250 rpm and approximately 1500 rpm, particularly between approximately 350 rpm and approximately 1200 rpm, preferably approximately 500 rpm. After temperature stabilization and optional rendering inert the atmosphere of the stirred medium, NaBH₄ solution is added by drip at constant flow rate, with values ranging from approximately 0.1 mL/hour to approximately 10.0 L/hour, preferably approximately 50 mL/hour. At this stage, the chemical reaction of conversion and formation of the metal nanoparticles is quickly obtained, forming a dispersion of reddish brown color. The reaction is terminated after the total addition of the reducing agent volume.

After the complete synthesis of metallic copper-base nanostructures, this is dried in two different routes depending on the application, i.e., as additives incorporated in compatible resins or polymers.

For the application in resins, the dispersion of nanostructures in an aqueous-based resin is added to an inert medium by inert gas, selected from helium, argon or nitrogen, preferably nitrogen, for application as surfaces with specific antimicrobial and antiviral activity. For the application in polymers, an inert medium by inert gas, selected from helium, argon or nitrogen, preferably nitrogen, is added to a water-soluble inert polymer, e.g. polyvinyl acetate (PVA) or the own coating polysaccharide biopolymers, for application as a test body with antimicrobial and antiviral activity

The drying of both structures is carried out by simple evaporation for approximately 6 to 12 hours in a greenhouse at approximately 80° C. or for approximately 24 to 48 hours at room temperature.

In inert medium by inert gas, selected from helium, argon or nitrogen, preferably nitrogen, the polysaccharide biopolymer is added for the dispersion of nanostructures to increase their mass proportion in relation to the metal copper nanoparticles. As another option, a polymer compatible with copper-based nanostructures and a polysaccharide biopolymer or cationic surfactant is also added to an inert gas medium, selected from helium, argon or nitrogen, preferably nitrogen, modifying the mass proportion between metal copper nanoparticles and other system components.

Optionally, the generated solutions can be dried by the drying spray technique or fluidized bed.

The terms “preferred” and “preferably” refer to modalities that may provide certain benefits in certain circumstances. However, other modalities may also be preferred under the same or other circumstances. In addition, the quote of one or more preferred modalities does not imply that other modalities are not used and should exclude other modalities from the scope of the invention

The following description will be based on preferential achievements of the invention. As it will be evident to any person skilled in the art, the invention is not limited to these particular achievements.

### EXAMPLES OF THE ACHIEVEMENTS OF THE INVENTION

### Example 1: Obtaining Metallic Copper Nanoparticles Coated With Chitosan

First, the synthesis of metal copper nanoparticles was performed by the method of chemical reduction coprecipitation in the presence of chitosan as a coating agent. In a 100 mL total borosilicate glass reactor, 5.00 mL of CuSO₄·5H₂O 0.10 mol/L solution, 25.00 mL of a 1.00% chitosan solution (mass/mass) solubilized in 0.50 mol/L acetic acid, 0.50 mL of an ascorbic acid solution 0.05 mol/L and 12.00 mL distilled water were mixed, submitted to mechanical stirring of 1000 rpm, nitrogen gas bubbling and 80° C. heating.

After 10 minutes for inerting the system and stabilization of the process parameters, still under stirring, 7.50 mL of NaBH₄ 0.10 mol/L solution was started in the system, which lasted approximately 15 minutes.

After feeding the reducing agent, the stirring was maintained for another 5 minutes under the same conditions. After stirring, nitrogen gas bubbling and heating were maintained.

The dispersion of reddish brown color was reserved in a 50.00 mL bottle, avoiding the presence of air columns, and packaged in an environment without the presence of light.

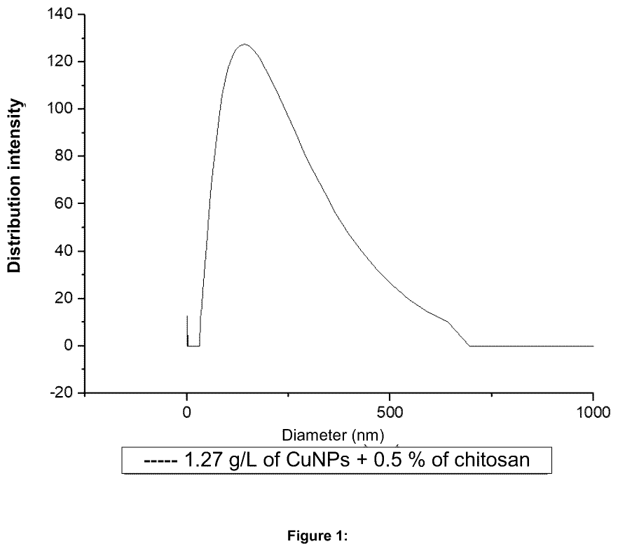

The generated sample was characterized by morphological and physical-chemical aspects. The dispersion size of the nanostructures was measured by dynamic light spreading (DLS), shown in FIG. 1, after dilution of 10 times (volume/volume), indicating an average hydrodynamic diameter of approximately 177 nm.

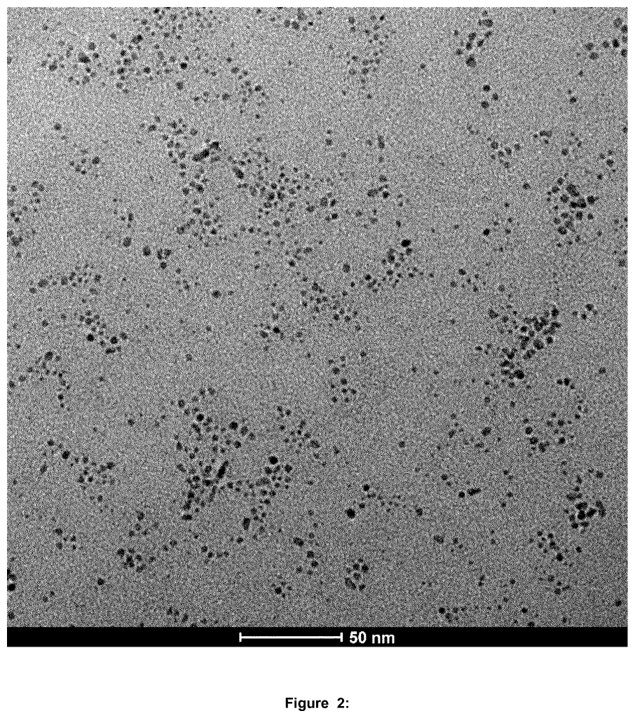

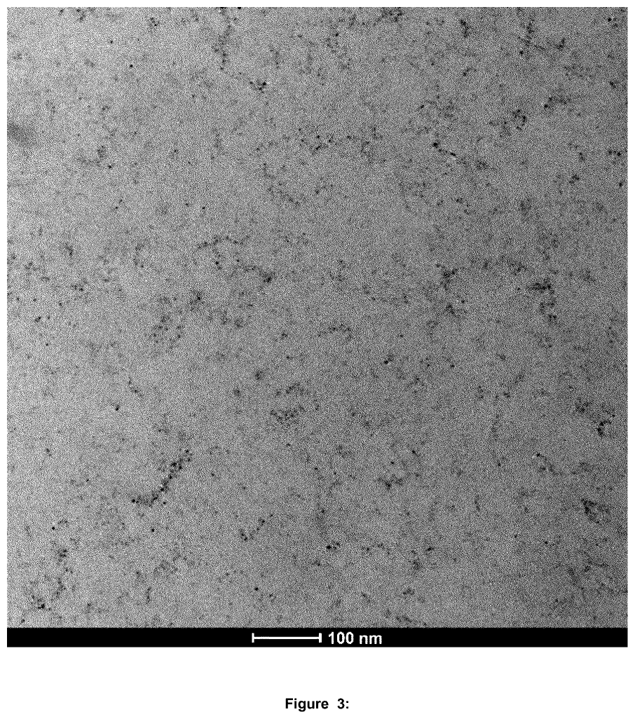

This diameter is consistent with its images by transmission electronic microscopy (TEM), shown in FIG. 2 and FIG. 3, where structures with size ranging from approximately 80 nm to 500 nm are noted.

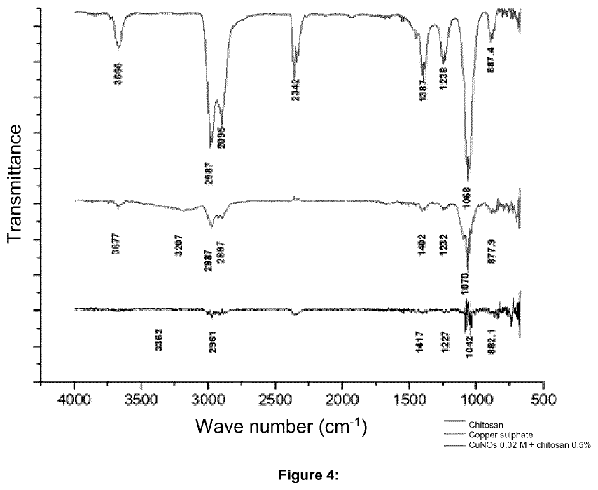

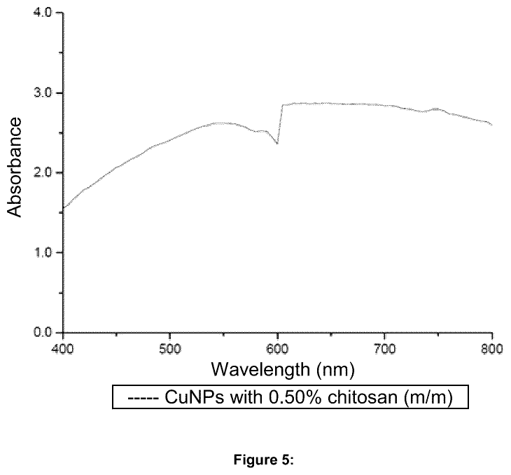

Infrared spectroscopy (FTIR), shown in FIG. 4, indicated the presence of metal copper nanoparticles and chitosan, with some changes in specific peaks, proving the interaction between the components. Ultraviolet and visible spectroscopy (UV-Vis), shown in FIG. 5, indicated the presence of copper nanoparticles in the system due to the presence of plasma resonance peak in the wavelength of 590 nm.

### Example 2: Obtaining Metallic Copper Nanoparticles Coated With Chitosan With Variation in Feeding

Tests were carried out for the synthesis of metal copper nanoparticles were held by the method of chemical reduction coprecipitation in the presence of chitosan as a coating agent in conditions similar to those described in Example. In these experiments, the ratio of molar concentration between copper and reducing agent was 1:1.5, and chitosan feeding to reactor was varied. The data are found on Table 1.

Based on the results of the characterization of particle size, the possibility or not of the formation of metal copper nanoparticles was verified by the feeding method used. By feeding the mixture of copper solutions, coating agent and antioxidant agent over the reducing agent solution there was copper oxidation, forming the cupric oxides (CuO) and cuprous (Cu₂O). By feeding the reducing agent solution on the mixture of copper solutions, coating agent and antioxidant agent, there was the formation of larger particles, approximately 1.5 μm. By the simultaneous feeding of the copper solution and reducing agent solution on the mixture of the coating agent and antioxidant agent solutions, there was the formation of smaller particles, approximately 400 nm.

### Example 3: Obtaining Metallic Copper Nanoparticles Coated With Chitosan With Variation Agents

Tests were carried out for the synthesis of metal copper nanoparticles were held by the method of chemical reduction coprecipitation in the presence of chitosan as a coating agent in conditions similar to those described in Example 1. In these experiments, the ratio of the molar concentration of copper and reducing agent was varied between 1:1 and 2:1. The data are found on Table 2.

Based on the results obtained from visual evaluation and characterization of particle size, the viability of the formation of metal copper nanoparticles and their chemical stability were verified by the presence of excessive copper or excessive reducing agent. For chitosan, the ratio of the molar concentrations of copper and reducing agent of 1:1, 1.5:1 and 2:1 showed low stability, where the metallic copper was rapidly re-oxidized, observing the formation of cupric ions (Cu²⁺) and the change of the system's color, from reddish brown to bluish. The ration between the molar concentrations of copper and reducing agent of 1:1.5 and 1:2 showed, respectively, the formation of metal copper nanoparticles, where the system is reddish brown in color, and the formation of copper oxide, where the system is blackened in color and the larger particles that they decant.

### Example 4: Obtaining Metallic Copper Nanoparticles Coated With Chitosan With Variation of Oxidizing Agents

Tests were carried out for the synthesis of metal copper nanoparticles were held by the method of chemical reduction coprecipitation in the presence of chitosan as a coating agent in conditions similar to those described in Example. In these experiments, the concentration of oxidizing agent was varied between 500 μmol/L and 10 mmol/L. The data are found on Table 3.

Based on the results obtained from visual evaluation and characterization of particle size, the stability of suspended nanoparticles was increased with the increase in the molar concentration of ascorbic acid in the system. Low ascorbic acid concentrations, 500 μmol/L and 1.0 mmol/L, presented low changes in dispersion stability. The concentration of 2.5 mmol/L increased dispersion stability in 10 days, maintaining good particle size homogeneity. The highest concentrations tested showed the formation of larger particles, as copper was reduced by excessive ascorbic acid before the feeding of the reducing agent, sodium borohydride solution, not ensuring particle size homogeneity and increasing particle size polydisperse.

TABLE 1
Synthesis of copper nanoparticles with chitosan and variation of feeding

| Chitosan/mtotal ratio variation | | | 0.10% | Chitosan/mtotal ratio variation | | | 0.20% |
|---|---|---|---|---|---|---|---|
| | Conc. | Conc. | Volume | | Conc. | Conc. | Volume |
| Reagent | (g/L) | (mol/L) | (mL) | Reagent | (g/L) | (mol/L) | (mL) |
| CuSO₄5H₂O | 24.969 | 0.100 | 5.00 | CuSO₄5H₂O | 24.969 | 0.100 | 5.00 |
| Chitosan | 10.000 | 0.000 | 5.00 | Chitosan | 10.000 | 0.000 | 10.00 |
| C/o. | 8.805 | 0.050 | 0.50 | C/o. | 8.805 | 0.050 | 0.50 |
| Ascorbic | | | | Ascorbic | | | |
| NₐBH₄ | 3.783 | 0.100 | 7.50 | NₐBH₄ | 3.783 | 0.100 | 7.50 |
| H₂O | — | — | 32.000 | H₂O | — | — | 27.000 |
| CuSO₄5H₂O | 24.969 | 0.100 | 5.00 | CuSO₄5H₂O | 24.969 | 0.100 | 5.00 |
| Chitosan | 10.000 | 0.000 | 5.00 | Chitosan | 10.000 | 0.000 | 10.00 |
| C/o. | 8.805 | 0.050 | 0.50 | C/o. | 8.805 | 0.050 | 0.50 |
| Ascorbic | | | | Ascorbic | | | |
| NₐBH₄ | 3.783 | 0.100 | 7.50 | NₐBH₄ | 3.783 | 0.100 | 7.50 |
| H₂O | — | — | 32.000 | H₂O | — | — | 27.000 |
| CuSO₄5H₂O | 24.969 | 0.100 | 5.00 | CuSO₄5H₂O | 24.969 | 0.100 | 5.00 |
| Chitosan | 10.000 | 0.000 | 5.00 | Chitosan | 10.000 | 0.000 | 10.00 |
| C/o. | 8.805 | 0.050 | 0.50 | C/o. | 8.805 | 0.050 | 0.50 |
| Ascorbic | | | | Ascorbic | | | |
| NₐBH₄ | 3.783 | 0.100 | 7.50 | NₐBH₄ | 3.783 | 0.100 | 7.50 |
| H₂O | — | — | 32.000 | H₂O | — | — | 27.000 |
| Chitosan/mtotal ratio variation | | | 0.30% | Chitosan/mtotal ratio variation | | | 0.40% |
| | Conc. | Conc. | Volume | | Conc. | Conc. | Volume |
| Reagent | (g/L) | (mol/L) | (mL) | Reagent | (g/L) | (mol/L) | (mL) |
| CuSO₄5H₂O | 24.969 | 0.100 | 5.00 | CuSO₄5H₂O | 24.969 | 0.100 | 5.00 |
| Chitosan | 10.000 | 0.000 | 15.00 | Chitosan | 10.000 | 0.000 | 20.00 |
| C/o. | 8.805 | 0.050 | 0.50 | C/o. | 8.805 | 0.050 | 0.50 |
| Ascorbic | | | | Ascorbic | | | |
| NₐBH₄ | 3.783 | 0.100 | 7.50 | NₐBH₄ | 3.783 | 0.100 | 7.50 |
| H₂O | — | — | 22.000 | H₂O | — | — | 17.000 |
| CuSO₄5H₂O | 24.969 | 0.100 | 5.00 | CuSO₄5H₂O | 24.969 | 0.100 | 5.00 |
| Chitosan | 10.000 | 0.000 | 15.00 | Chitosan | 10.000 | 0.000 | 20.00 |
| C/o. | 8.805 | 0.050 | 0.50 | C/o. | 8.805 | 0.050 | 0.50 |
| Ascorbic | | | | Ascorbic | | | |
| NₐBH₄ | 3.783 | 0.100 | 7.50 | NₐBH₄ | 3.783 | 0.100 | 7.50 |
| H₂O | — | — | 22.000 | H₂O | — | — | 17.000 |
| CuSO₄5H₂O | 24.969 | 0.100 | 5.00 | CuSO₄5H₂O | 24.969 | 0.100 | 5.00 |
| Chitosan | 10.000 | 0.000 | 15.00 | Chitosan | 10.000 | 0.000 | 20.00 |
| C/o. | 8.805 | 0.050 | 0.50 | C/o. | 8.805 | 0.050 | 0.50 |
| Ascorbic | | | | Ascorbic | | | |
| NₐBH₄ | 3.783 | 0.100 | 7.50 | NₐBH₄ | 3.783 | 0.100 | 7.50 |
| H₂O | — | — | 22.000 | H₂O | — | — | 17.000 |

| Chitosan/mtotal ratio variation | | | 0.50% | | |
|---|---|---|---|---|---|
| | Conc. | Conc. | Volume | | |
| Reagent | (g/L) | (mol/L) | (mL) | Note | |
| CuSO₄5H₂O | 24.969 | 0.100 | 5.00 | Ratio of | Load |
| Chitosan | 10.000 | 0.000 | 25.00 | [Cu]/ag. | reactor |
| C/o. | 8.805 | 0.050 | 0.50 | red.] = | with |
| Ascorbic | | | | 1:1.5 | copper |
| NₐBH₄ | 3.783 | 0.100 | 7.50 | | sulphate, |
| H₂O | — | — | 12.000 | | chitosan, |
| | | | | | ascorbic |
| | | | | | acid and |
| | | | | | water and |
| | | | | | drip the |
| | | | | | reducing |
| | | | | | reagent |
| CuSO₄5H₂O | 24.969 | 0.100 | 5.00 | Ratio of | Load |
| Chitosan | 10.000 | 0.000 | 25.00 | [Cu]/ag. | reactor |
| C/o. | 8.805 | 0.050 | 0.50 | red.] = | with |
| Ascorbic | | | | 1:1.5 | reducing |
| NₐBH₄ | 3.783 | 0.100 | 7.50 | | agent, |
| H₂O | — | — | 12.000 | | ascorbic |
| | | | | | acid and |
| | | | | | water and |
| | | | | | drip the |
| | | | | | copper |
| | | | | | sulphate |
| | | | | | and |
| | | | | | chitosan |
| CuSO₄5H₂O | 24.969 | 0.100 | 5.00 | Ratio of | Load |
| Chitosan | 10.000 | 0.000 | 25.00 | [Cu]/ag. | reactor |
| C/o. | 8.805 | 0.050 | 0.50 | red.] = | with |
| Ascorbic | | | | 1:1.5 | chitosan, |
| NₐBH₄ | 3.783 | 0.100 | 7.50 | | ascorbic |
| H₂O | — | — | 12.000 | | acid and |
| | | | | | water and |
| | | | | | drip the |
| | | | | | copper |
| | | | | | sulphate |
| | | | | | and |
| | | | | | reducing |
| | | | | | agent |
| | | | | | simultaneously |

TABLE 2
Synthesis of copper nanoparticles with chitosan and variation of reducing agent

| Chitosan/mtotal ratio variation | | | 0.10% | Chitosan/mtotal ratio variation | | | 0.20% |
|---|---|---|---|---|---|---|---|
| | Conc. | Conc. | Volume | | Conc. | Conc. | Volume |
| Reagent | (g/L) | (mol/L) | (mL) | Reagent | (g/L) | (mol/L) | (mL) |
| CuSO₄5H₂O | 24.969 | 0.100 | 5.00 | CuSO₄5H₂O | 24.969 | 0.100 | 5.00 |
| Chitosan | 10.000 | 0.000 | 5.00 | Chitosan | 10.000 | 0.000 | 10.00 |
| C/o. | 8.805 | 0.050 | 0.50 | C/o. | 8.805 | 0.050 | 0.50 |
| Ascorbic | | | | Ascorbic | | | |
| NₐBH₄ | 3.783 | 0.100 | 7.50 | NₐBH₄ | 3.783 | 0.100 | 5.00 |
| H₂O | — | — | 34.500 | H₂O | — | — | 29.500 |
| CuSO₄5H₂O | 24.969 | 0.100 | 5.00 | CuSO₄5H₂O | 24.969 | 0.100 | 5.00 |
| Chitosan | 10.000 | 0.000 | 5.00 | Chitosan | 10.000 | 0.000 | 10.00 |
| C/o. | 8.805 | 0.050 | 0.50 | C/o. | 8.805 | 0.050 | 0.50 |
| Ascorbic | | | | Ascorbic | | | |
| NₐBH₄ | 3.783 | 0.100 | 7.50 | NₐBH₄ | 3.783 | 0.100 | 7.50 |
| H₂O | — | — | 32.500 | H₂O | — | — | 27.000 |
| CuSO₄5H₂O | 24.969 | 0.100 | 5.00 | CuSO₄5H₂O | 24.969 | 0.100 | 5.00 |
| Chitosan | 10.000 | 0.000 | 5.00 | Chitosan | 10.000 | 0.000 | 10.00 |
| C/o. | 8.805 | 0.050 | 0.50 | C/o. | 8.805 | 0.050 | 0.50 |
| Ascorbic | | | | Ascorbic | | | |
| NₐBH₄ | 3.783 | 0.100 | 10.00 | NₐBH₄ | 3.783 | 0.100 | 10.00 |
| H₂O | — | — | 29.500 | H₂O | — | — | 24.500 |
| CuSO₄5H₂O | 24.969 | 0.100 | 5.00 | CuSO₄5H₂O | 24.969 | 0.100 | 5.00 |
| Chitosan | 10.000 | 0.000 | 5.00 | Chitosan | 10.000 | 0.000 | 10.00 |
| C/o. | 8.805 | 0.050 | 0.50 | C/o. | 8.805 | 0.050 | 0.50 |
| Ascorbic | | | | Ascorbic | | | |
| NₐBH₄ | 3.783 | 0.100 | 3.33 | NₐBH₄ | 3.783 | 0.100 | 3.33 |
| H₂O | — | — | 36.167 | H₂O | — | — | 31.167 |
| CuSO₄5H₂O | 24.969 | 0.100 | 5.00 | CuSO₄5H₂O | 24.969 | 0.100 | 5.00 |
| Chitosan | 10.000 | 0.000 | 5.00 | Chitosan | 10.000 | 0.000 | 10.00 |
| C/o. | 8.805 | 0.050 | 0.50 | C/o. | 8.805 | 0.050 | 0.50 |
| Ascorbic | | | | Ascorbic | | | |
| NₐBH₄ | 3.783 | 0.100 | 2.50 | NₐBH₄ | 3.783 | 0.100 | 2.50 |
| H₂O | — | — | 37.000 | H₂O | — | — | 32.000 |

| Chitosan/mtotal ratio variation | | | 0.30% | Chitosan/mtotal ratio variation | | | 0.40% |
|---|---|---|---|---|---|---|---|
| | Conc. | Conc. | Volume | | Conc. | Conc. | Volume |
| Reagent | (g/L) | (mol/L) | (mL) | Reagent | (g/L) | (mol/L) | (mL) |
| CuSO₄5H₂O | 24.969 | 0.100 | 5.00 | CuSO₄5H₂O | 24.969 | 0.100 | 5.00 |
| Chitosan | 10.000 | 0.000 | 15.00 | Chitosan | 10.000 | 0.000 | 20.00 |
| C/o. | 8.805 | 0.050 | 0.50 | C/o. | 8.805 | 0.050 | 0.50 |
| Ascorbic | | | | Ascorbic | | | |
| NₐBH₄ | 3.783 | 0.100 | 5.00 | NₐBH₄ | 3.783 | 0.100 | 5.00 |
| H₂O | — | — | 24.500 | H₂O | — | — | 19.500 |
| CuSO₄5H₂O | 24.969 | 0.100 | 5.00 | CuSO₄5H₂O | 24.969 | 0.100 | 5.00 |
| Chitosan | 10.000 | 0.000 | 15.00 | Chitosan | 10.000 | 0.000 | 20.00 |
| C/o. | 8.805 | 0.050 | 0.50 | C/o. | 8.805 | 0.050 | 0.50 |
| Ascorbic | | | | Ascorbic | | | |
| NₐBH₄ | 3.783 | 0.100 | 7.50 | NₐBH₄ | 3.783 | 0.100 | 7.50 |
| H₂O | — | — | 22.000 | H₂O | — | — | 17.000 |
| CuSO₄5H₂O | 24.969 | 0.100 | 5.00 | CuSO₄5H₂O | 24.969 | 0.100 | 5.00 |
| Chitosan | 10.000 | 0.000 | 15.00 | Chitosan | 10.000 | 0.000 | 20.00 |
| C/o. | 8.805 | 0.050 | 0.50 | C/o. Ascorbic | 8.805 | 0.050 | 0.50 |
| Ascorbic | | | | | | | |
| NₐBH₄ | 3.783 | 0.100 | 10.00 | NₐBH₄ | 3.783 | 0.100 | 10.00 |
| H₂O | — | — | 19.500 | H₂O | — | — | 14.500 |
| CuSO₄5H₂O | 24.969 | 0.100 | 5.00 | CuSO₄5H₂O | 24.969 | 0.100 | 5.00 |
| Chitosan | 10.000 | 0.000 | 15.00 | Chitosan | 10.000 | 0.000 | 20.00 |
| C/o. | 8.805 | 0.050 | 0.50 | C/o. | 8.805 | 0.050 | 0.50 |
| Ascorbic | | | | Ascorbic | | | |
| NₐBH₄ | 3.783 | 0.100 | 3.33 | NₐBH₄ | 3.783 | 0.100 | 3.33 |
| H₂O | — | — | 26.167 | H₂O | — | — | 21.167 |
| CuSO₄5H₂O | 24.969 | 0.100 | 5.00 | CuSO₄5H₂O | 24.969 | 0.100 | 5.00 |
| Chitosan | 10.000 | 0.000 | 15.00 | Chitosan | 10.000 | 0.000 | 20.00 |
| C/o. | 8.805 | 0.050 | 0.50 | C/o. | 8.805 | 0.050 | 0.50 |
| Ascorbic | | | | Ascorbic | | | |
| NₐBH₄ | 3.783 | 0.100 | 2.50 | NₐBH₄ | 3.783 | 0.100 | 2.50 |
| H₂O | — | — | 27.000 | H₂O | — | — | 22.000 |

| Chitosan/mtotal ratio variation | | | 0.50% | | |
|---|---|---|---|---|---|
| | Conc. | Conc. | Volume | | |
| Reagent | (g/L) | (mol/L) | (mL) | Note | |
| CuSO₄5H₂O | 24.969 | 0.100 | 5.00 | Ratio of | Load |
| Chitosan | 10.000 | 0.000 | 25.00 | [Cu]/ag. | reactor |
| C/o. | 8.805 | 0.050 | 0.50 | red.] = | with |
| Ascorbic | | | | 1:1.5 | copper |
| NₐBH₄ | 3.783 | 0.100 | 5.00 | | sulphate, |
| H₂O | — | — | 14.500 | | chitosan, |
| | | | | | ascorbic |
| | | | | | acid and |
| | | | | | water and |
| | | | | | drip the |
| | | | | | reducing |
| | | | | | agent |
| CuSO₄5H₂O | 24.969 | 0.100 | 5.00 | Ratio of | Load |
| Chitosan | 10.000 | 0.000 | 25.00 | [Cu]/ag. | reactor |
| C/o. | 8.805 | 0.050 | 0.50 | red.] = | with |
| Ascorbic | | | | 1:1.5 | copper |
| NₐBH₄ | 3.783 | 0.100 | 7.50 | | sulphate, |
| H₂O | — | — | 12.000 | | chitosan, |
| | | | | | ascorbic |
| | | | | | acid and |
| | | | | | water and |
| | | | | | drip the |
| | | | | | reducing |
| | | | | | agent |
| CuSO₄5H₂O | 24.969 | 0.100 | 5.00 | Ratio of | Load |
| Chitosan | 10.000 | 0.000 | 25.00 | [Cu]/ag. | reactor |
| C/o. | 8.805 | 0.050 | 0.50 | red.] = | with |
| Ascorbic | | | | 1:2 | copper |
| NₐBH₄ | 3.783 | 0.100 | 10.00 | | sulphate, |
| H₂O | — | — | 9.500 | | chitosan, |
| | | | | | ascorbic |
| | | | | | acid and |
| | | | | | water and |
| | | | | | drip the |
| | | | | | reducing |
| | | | | | agent |
| CuSO₄5H₂O | 24.969 | 0.100 | 5.00 | Ratio of | Load |
| Chitosan | 10.000 | 0.000 | 25.00 | [Cu]/ag. | reactor |
| C/o. | 8.805 | 0.050 | 0.50 | red.] = | with |
| Ascorbic | | | | 1:1.5 | copper |
| NₐBH₄ | 3.783 | 0.100 | 3.33 | | sulphate, |
| H₂O | — | — | 16.167 | | chitosan, |
| | | | | | ascorbic |
| | | | | | acid and |
| | | | | | water |
| | | | | | and drip |
| | | | | | the |
| | | | | | reducing |
| | | | | | agent |
| CuSO₄5H₂O | 24.969 | 0.100 | 5.00 | Ratio of | Load |
| Chitosan | 10.000 | 0.000 | 25.00 | [Cu]/ag. | reactor |
| C/o. | 8.805 | 0.050 | 0.50 | red.] = | with |
| Ascorbic | | | | 2:1 | copper |
| NₐBH₄ | 3.783 | 0.100 | 2.50 | | sulphate, |
| H₂O | — | — | 17.000 | | chitosan, |
| | | | | | ascorbic |
| | | | | | acid and |
| | | | | | water |
| | | | | | and drip |
| | | | | | the |
| | | | | | reducing |
| | | | | | agent |

TABLE 3
Synthesis of copper nanoparticles with chitosan and variation of oxidizing agent

| Chitosan/mtotal ratio variation | | | 0.30% | | Chitosan/mtotal ratio variation | | | 0.40% | |
|---|---|---|---|---|---|---|---|---|---|
| | Conc. | Conc. | Volume | | | | Conc. | Volume | |
| Reagent | (g/L) | (mol/L) | (mL) | Var. pH | Reagent | Conc. (g/L) | (mol/L) | (mL) | Var. pH |
| CuSO₄5H₂O | 24.969 | 0.100 | 5.00 | Initial pH | CuSO₄5H₂O | 24.969 | 0.100 | 5.00 | Initial pH |
| Chitosan | 10.000 | 0.000 | 15.00 | 3.41 | Chitosan | 10.000 | 0.000 | 20.00 | 3.49 |
| C/o. | 8.805 | 0.050 | 0.50 | Final pH | C/o. | 8.805 | 0.050 | 0.50 | Final pH |
| Ascorbic | | | | | Ascorbic | | | | |
| NₐBH₄ | 3.783 | 0.100 | 7.50 | | NₐBH₄ | 3.783 | 0.100 | 7.50 | |
| H₂O | — | — | 22.000 | 3.62 | H₂O | — | — | 17.000 | 3.66 |
| CuSO₄5H₂O | 24.969 | 0.100 | 5.00 | Initial pH | CuSO₄5H₂O | 24.969 | 0.100 | 5.00 | Initial pH |
| Chitosan | 10.000 | 0.000 | 15.00 | 3.45 | Chitosan | 10.000 | 0.000 | 20.00 | 3.50 |
| C/o. | 8.805 | 0.050 | 1.00 | Final pH | C/o. | 8.805 | 0.050 | 1.00 | Final pH |
| Ascorbic | | | | | Ascorbic | | | | |
| NₐBH₄ | 3.783 | 0.100 | 7.50 | | NₐBH₄ | 3.783 | 0.100 | 7.50 | |
| H₂O | — | — | 21.500 | 3.82 | H₂O | — | — | 16.500 | 3.87 |
| CuSO₄5H₂O | 24.969 | 0.100 | 5.00 | Initial pH | CuSO₄5H₂O | 24.969 | 0.100 | 5.00 | Initial pH |
| Chitosan | 10.000 | 0.000 | 15.00 | 3.46 | Chitosan | 10.000 | 0.000 | 20.00 | 3.46 |
| C/o. | 8.805 | 0.050 | 2.50 | Final pH | C/o. | 8.805 | 0.050 | 2.50 | Final pH |
| Ascorbic | | | | | Ascorbic | | | | |
| NₐBH₄ | 3.783 | 0.100 | 7.50 | | NₐBH₄ | 3.783 | 0.100 | 7.50 | |
| H₂O | — | — | 20.000 | 3.84 | H₂O | — | — | 15.000 | 3.66 |
| CuSO₄5H₂O | 24.969 | 0.100 | 5.00 | Initial pH | CuSO₄5H₂O | 24.969 | 0.100 | 5.00 | Initial pH |
| Chitosan | 10.000 | 0.000 | 15.00 | 3.39 | Chitosan | 10.000 | 0.000 | 20.00 | 3.42 |
| C/o. | 8.805 | 0.050 | 0.50 | Final pH | C/o. | 8.805 | 0.050 | 0.50 | Final |
| Ascorbic | | | | | Ascorbic | | | | |
| NₐBH₄ | 3.783 | 0.100 | 7.50 | | NₐBH₄ | 3.783 | 0.100 | 7.50 | pH |
| H₂O | — | — | 17.500 | 3.29 | H₂O | — | — | 12.500 | 3.53 |
| CuSO₄5H₂O | 24.969 | 0.100 | 5.00 | Initial pH | CuSO₄5H₂O | 24.969 | 0.100 | 5.00 | Initial pH |
| Chitosan | 10.000 | 0.000 | 15.00 | 2.79 | Chitosan | 10.000 | 0.000 | 20.00 | 3.16 |
| C/o. | 8.805 | 0.050 | 10.00 | Final pH | C/o. | 8.805 | 0.050 | 10.00 | Final |
| Ascorbic | | | | | Ascorbic | | | | |
| NₐBH₄ | 3.783 | 0.100 | 7.50 | | NₐBH₄ | 3.783 | 0.100 | 7.50 | pH |
| H₂O | — | — | 12.500 | 2.82 | H₂O | — | — | 7.500 | 3.48 |

| Chitosan/mtotal ratio variation | | | 0.50% | | | |
|---|---|---|---|---|---|---|
| Reagent | Conc. (g/L) | Conc. (mol/L) | Volume (mL) | Var. pH | | |
| CuSO₄5H₂O | 24.969 | 0.100 | 5.00 | Initial pH | Ratio of | Load |
| Chitosan | 10.000 | 0.000 | 25.00 | 3.46 | [Cu]/[ag. | reactor |
| C/o. | 8.805 | 0.050 | 0.50 | Final pH | Red.] = | with copper |
| Ascorbic | | | | | 1:1.5 | sulphate, |
| NₐBH₄ | 3.783 | 0.100 | 7.50 | | | chitosan, |
| H₂O | — | — | 12.000 | 3.77 | | ascorbic |
| | | | | | | acid and |
| | | | | | | water and |
| | | | | | | drip the |
| | | | | | | reducing |
| | | | | | | agent |
| CuSO₄5H₂O | 24.969 | 0.100 | 5.00 | Initial pH | Ratio of | Load |
| Chitosan | 10.000 | 0.000 | 25.00 | 3.46 | [Cu]/[ag. | reactor |
| C/o. | 8.805 | 0.050 | 1.00 | Final pH | Red.] = | with copper |
| Ascorbic | | | | | 1:1.5 | sulphate, |
| NₐBH₄ | 3.783 | 0.100 | 7.50 | | | chitosan, |
| H₂O | — | — | 11.500 | 3.85 | | ascorbic |
| | | | | | | acid and |
| | | | | | | water and |
| | | | | | | drip the |
| | | | | | | reducing |
| | | | | | | agent |
| CuSO₄5H₂O | 24.969 | 0.100 | 5.00 | Initial pH | Ratio of | Load |
| Chitosan | 10.000 | 0.000 | 25.00 | 3.49 | [Cu]/[ag. | reactor |
| C/o. | 8.805 | 0.050 | 2.50 | Final pH | Red.] = | with copper |
| Ascorbic | | | | | 1:1.5 | sulphate, |
| NₐBH₄ | 3.783 | 0.100 | 7.50 | | | chitosan, |
| H₂O | — | — | 10.000 | 3.58 | | ascorbic |
| | | | | | | acid and |
| | | | | | | water and |
| | | | | | | drip the |
| | | | | | | reducing |
| | | | | | | agent |
| CuSO₄5H₂O | 24.969 | 0.100 | 5.00 | Initial pH | Ratio of | Load |
| Chitosan | 10.000 | 0.000 | 25.00 | 3.34 | [Cu]/[ag. | reactor |
| C/o. | 8.805 | 0.050 | 5.00 | Final pH | Red.] = | with |
| Ascorbic | | | | | 1:1.5 | copper |
| NₐBH₄ | 3.783 | 0.100 | 7.50 | | | sulphate, |
| H₂O | — | — | 7.500 | 3.53 | | chitosan, |
| | | | | | | ascorbic |
| | | | | | | acid and |
| | | | | | | water and |
| | | | | | | drip the |
| | | | | | | reducing |
| | | | | | | agent |
| CuSO₄5H₂O | 24.969 | 0.100 | 5.00 | Initial pH | Ratio of | Load |
| Chitosan | 10.000 | 0.000 | 25.00 | 3.16 | [Cu]/[ag. | reactor |
| C/o. | 8.805 | 0.050 | 10.00 | Final pH | Red.] = | with |
| Ascorbic | | | | | 1:1.5 | copper |
| NₐBH₄ | 3.783 | 0.100 | 7.50 | | | sulphate, |
| H₂O | — | — | 7.500 | 3.43 | | chitosan, |
| | | | | | | ascorbic |
| | | | | | | acid and |
| | | | | | | water and |
| | | | | | | drip the |
| | | | | | | reducing |
| | | | | | | agent |

| Chitosan/mtotal ratio variation | | | | | | |
|---|---|---|---|---|---|---|
| Reagent | Conc. (g/L) | Conc. (mol/L) | | | | |
| CuSO₄5H₂O | 24.969 | 0.100 | 1000 | 60° C. | Initial | [Ascorbic |
| Chitosan | 10.000 | 0.000 | rpm | synthesis | pH = | acid] = |
| C/o. | 8.805 | 0.050 | stirring | temperature | 4.0 | 500 |
| Ascorbic | | | speed | | | μmol/L. |
| NₐBH₄ | 3.783 | 0.100 | | | | |
| H₂O | — | — | | | | |
| CuSO₄5H₂O | 24.969 | 0.100 | 1000 | 60° C. | Initial | [Ascorbic |
| Chitosan | 10.000 | 0.000 | rpm | synthesis | pH = | acid] = |
| C/o. | 8.805 | 0.050 | stirring | temperature | 4.0 | 1.0 |
| Ascorbic | | | speed | | | mmol/L. |
| NₐBH₄ | 3.783 | 0.100 | | | | |
| H₂O | — | — | | | | |
| CuSO₄5H₂O | 24.969 | 0.100 | 1000 | 60° C. | Initial | [Ascorbic |
| Chitosan | 10.000 | 0.000 | rpm | synthesis | pH = | acid] = |
| C/o. | 8.805 | 0.050 | stirring | temperature | 4.0 | 2.5 |
| Ascorbic | | | speed | | | mmol/L. |
| NₐBH₄ | 3.783 | 0.100 | | | | |
| H₂O | — | — | | | | |
| CuSO₄5H₂O | 24.969 | 0.100 | 1000 | 60° C. | Initial | [Ascorbic |
| Chitosan | 10.000 | 0.000 | rpm | synthesis | pH = | acid] = |
| C/o. | 8.805 | 0.050 | stirring | temperature | 4.0 | 5.0 |
| Ascorbic | | | speed | | | μmol/L. |
| NₐBH₄ | 3.783 | 0.100 | | | | |
| H₂O | — | — | | | | |
| CuSO₄5H₂O | 24.969 | 0.100 | 1000 | 60° C. | Initial | [Ascorbic |
| Chitosan | 10.000 | 0.000 | rpm | synthesis | pH = | acid] = |
| C/o. | 8.805 | 0.050 | stirring | temperature | 4.0 | 10.0 |
| Ascorbic | | | speed | | | μmol/L. |
| NₐBH₄ | 3.783 | 0.100 | | | | |
| H₂O | — | — | | | | |

### Example 5: Obtaining Metallic Copper Nanoparticles Coated With Carboxymethyl Cellulose

First, the synthesis of metal copper nanoparticles was performed by the method of chemical reduction coprecipitation in the presence of carboxymethyl cellulose as a coating agent. In a 100 mL total borosilicate glass reactor, 10.00 mL of carboxymethyl cellulose solution, 5.00% (mass/mass) solubilized in distilled water, 0.50 mL of an ascorbic acid solution 0.05 mol/L and 29.50 mL distilled water were mixed, submitted to mechanical stirring of 1000 rpm, nitrogen gas bubbling and 40° C. heating.

After 10 minutes for inerting the system and stabilization of the process parameters, still under stirring, 5.00 mL of NaBH₄ 0.10 mol/L solution and 5.00 mL of CuSO₄·5H₂O 0.10 mol/L simultaneous dripping was started in the system, which lasted approximately 15 minutes.

After feeding the reducing agent and substrate, the stirring was maintained for another 5 minutes under the same conditions. After stirring, nitrogen gas bubbling and heating were maintained.

The dispersion of reddish brown color was reserved in a 50.00 mL bottle, avoiding the presence of air columns, and packaged in an environment without the presence of light.

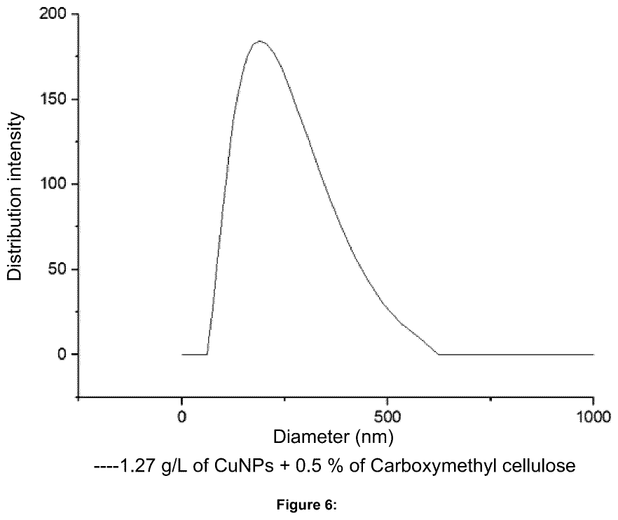

Analysis of sample DLS is depicted in FIG. 6, showing an average hydrodynamic diameter of approximately 240 nm.

### Example 6: Obtaining Copper Nanoparticles Coated With Acacia Gum

First, the synthesis of metal copper nanoparticles was performed by the method of chemical reduction coprecipitation in the presence of acacia gum a coating agent. In a 100 mL total borosilicate glass reactor, 5.00 mL of CuSO₄·5H₂O 0.20 mol/L solution, 12.50 mL of a 4.00% Acacia gum (mass/mass) solubilized in water, and 12.00 mL distilled water were mixed, submitted to mechanical stirring of 5000 rpm, nitrogen gas bubbling 25° C. temperature.

After 10 minutes for inerting the system and stabilization of the process parameters, still under stirring, 32.50 mL of NaBH₄ 0.03 mol/L solution was started slowly adding in the system, which lasted approximately 5 minutes.

After feeding the reducing agent, the stirring was maintained for another 5 minutes under the same conditions. By ending the stirring, nitrogen gas bubbling were maintained.

The dispersion of reddish brown color was reserved in a 50.00 mL bottle, avoiding the presence of air columns, and packaged in an environment without the presence of light.

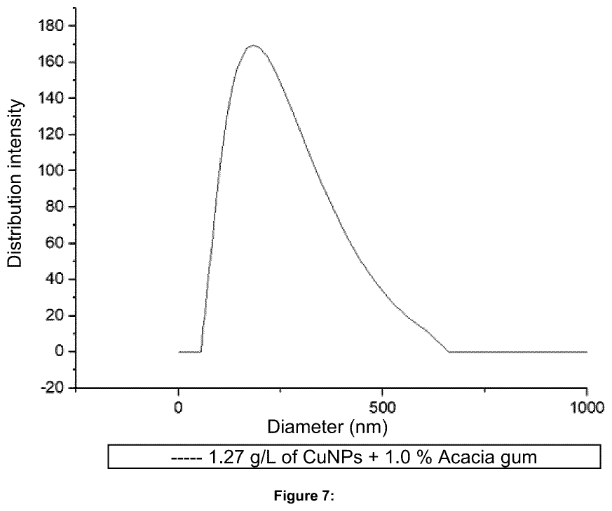

Analysis of sample DLS is depicted in FIG. 7, showing an average hydrodynamic diameter of approximately 266 nm.

### Example 7: Obtaining Copper Nanoparticles Coated With Cetylperidinium Chloride

First, the synthesis of metal copper nanoparticles was performed by the method of chemical reduction coprecipitation in the presence of cetylperidinium chloride as a coating agent. In a 100 mL total borosilicate glass reactor, 5.00 mL of CuSO₄·5H₂O 0.10 mol/L solution, 1.00 mL of a 1.00% cetylperidinium chloride solution (mass/mass) solubilized in distilled water, 0.50 mL of an ascorbic acid solution 0.05 mol/L and 38.50 mL distilled water were mixed, submitted to mechanical stirring of 750 rpm, nitrogen gas bubbling and 25° C.

After 10 minutes for inerting the system and stabilization of the process parameters, still under stirring, 7.50 mL of NaBH₄ 0.10 mol/L solution was started in the system, which lasted approximately 15 minutes.

After feeding the reducing agent, the stirring was maintained for another 5 minutes under the same conditions. After stirring, nitrogen gas bubbling and heating were maintained.

The dispersion of reddish brown color was reserved in a 50.00 mL bottle, avoiding the presence of air columns, and packaged in an environment without the presence of light.

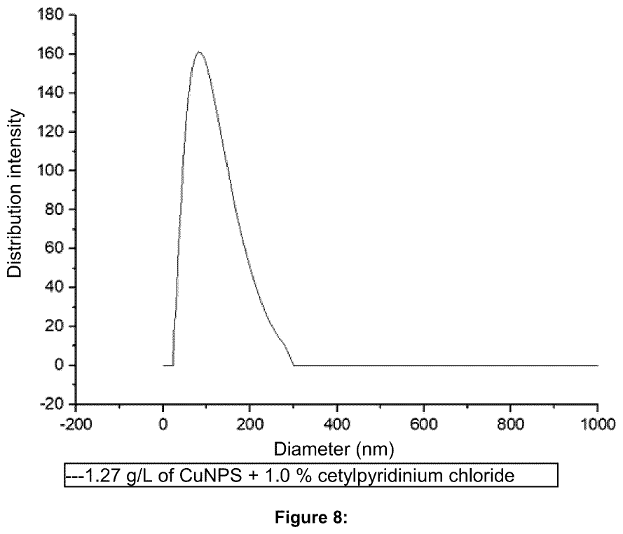

Analysis of sample DLS is depicted in FIG. 8, showing an average hydrodynamic diameter of approximately 70 nm.

### Example 8: Obtaining Copper Nanoparticles Coated With Ethoxylate Sorbitano Monolaurate 80

First, the synthesis of metal copper nanoparticles was performed by the method of chemical reduction coprecipitation in the presence of ethoxylate sorbitano monolaurate 80 as a coating agent. In a 100 mL total borosilicate glass reactor, 10.00 mL of CuSO₄·5H₂O 0.10 mol/L solution, 10.00 mL of ethoxylate sorbitano monolaurate 80 5.00% (mass/mass) solubilized in distilled water were mixed, submitted to mechanical stirring of 500 rpm, nitrogen gas bubbling temperature and at 25° C.

After 10 minutes for inerting the system and stabilization of the process parameters, still under stirring, 30.00 mL of NaBH₄ 5.00 mmol/L solution was started slowly adding in the system, which lasted approximately 15 minutes.

After feeding the reducing agent, the stirring was maintained for another 5 minutes under the same conditions. After stirring, nitrogen gas bubbling and heating were maintained.

The dispersion of reddish brown color was reserved in a 50.00 mL bottle, avoiding the presence of air columns, and packaged in an environment without the presence of light.

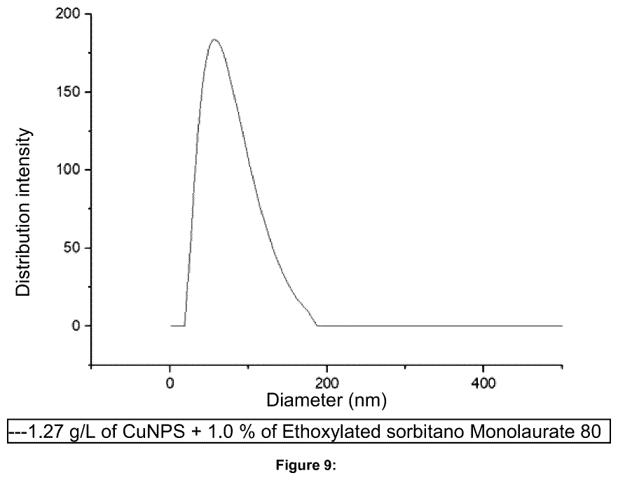

Analysis of sample DLS is depicted in FIG. 9, showing an average hydrodynamic diameter of approximately 64 nm.

### Example 9: Obtaining Copper Nanoparticles Coated With Cocoamidopropyl Betaine

First, the synthesis of metal copper nanoparticles was performed by the method of chemical reduction coprecipitation in the presence of cocoamidopropyl betaine as coating agent. In a 100 mL total borosilicate glass reactor, 5.00 mL of CuSO₄·5H₂O 0.10 mol/L solution, and 28.60 mL of cocoamidopropyl betaine 3.50% (mass/mass) solubilized in distilled water were And submitted to mechanical stirring of 500 rpm, nitrogen gas bubbling temperature and at 25° C.

After 10 minutes for inerting the system and stabilization of the process parameters, still under stirring, 14.60 mL of NaBH₄ 14.00 mmol/L solution was started slowly adding in the system, which lasted approximately 5 minutes.

After feeding the reducing agent, the stirring was maintained for another 5 minutes under the same conditions. After stirring, nitrogen gas bubbling and heating were maintained.

The dispersion of reddish brown color was reserved in a 50.00 mL bottle, avoiding the presence of air columns, and packaged in an environment without the presence of light.

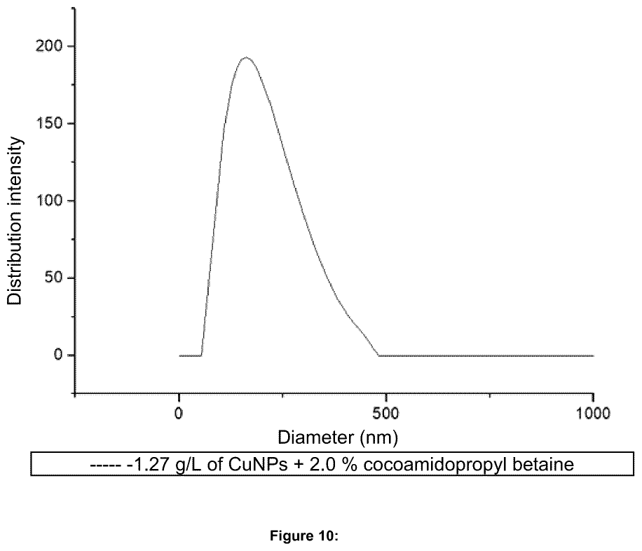

Analysis of sample DLS is depicted in FIG. 10, showing an average hydrodynamic diameter of approximately 35 nm.

### Example 10: Application of Nano-Structure Dispersion to Copper Base Against Bacteria

Antibacterial tests in relation to the bacterial strains Gram− which are Escherichia coli and Pseudomonas aeruginosa, and Gram +, which are Staphylococcus aureus and Streptococcus agalactiae, showed there was a biocidal potential in relation to control. More than that, in most cases, the viability of bacteria decreased in a few hours, indicating that these species have low resistance to nanoparticles, probably due to the interaction with their cell membrane and internal organelles.

The results indicated the antimicrobial potential of nanostructure dispersions based on metallic copper, since it was observed that there was a reduction of approximately 99.999% of the microbial load evaluated after exposure to nanostructures. This fact can be explored for the use of particles embedded in a target vector of application, such as in compatible resins or polymeric materials and sanitizing products.

### Example 11: Application of Nano-Structure Dispersion to Copper Base Against Yeast

Antifungal test in relation to the strain of yeast Candida albicans showed that there was a biocidal potential in relation to the control. More than that, in most cases, the viability of cell decreased in a few hours, indicating that these cells have low resistance by particles, probably due to the interaction with their cell membrane and internal organelles.

The results indicated the antifungal potential of nanostructure dispersions based on metallic copper, since it was observed that there was a reduction of approximately 99.999% of the microbial load evaluated after exposure to nanostructures. This fact can be explored for the use of particles embedded in a target vector of application, such as in compatible resins or polymeric materials and sanitizing products.

### Example 12: Application of Dispersion of Copper Base Nanostructure Against Yeast

An enveloped virus was used as a model in this evaluation. Viral suspensions of canine coronavirus, an RNA virus, produced in A72 cells (canine fibrosarcoma), were exposed to dispersions of metallic copper base nanostructures for a period of 10 minutes.

Virus survival was evaluated by titration in cells of the A72 strain for the determination of viral load reduction. The presence of the virus is evidenced by the cellular rupture (cytopathic effect) observed in an optical microscope.

Titration tests were carried out on 96-well plates with cell suspensions containing 1×10⁵ cells/mL. After 24 hours for cell adhesion, monolayer was exposed to preparations of viral suspension of coronavirus applied for the test using serial dilutions until viral titer was found, as well as viral preparations after exposure with dispersion of metal copper-based nanostructures.

After evaluation at the optical microscope, it was possible to determine no cell death was observed indicating viral inactivation.

The results indicated the antiviral potential of nanostructure dispersions based on metallic copper, since it was observed that there was a reduction of approximately 99.999% of the microbial load evaluated after exposure to nanostructures. This fact can be explored for the use of particles embedded in a target vector of application, such as in compatible resins or polymeric materials and sanitizing products.

### Example 13: Incorporation of the Metallic Copper Base Nanostructures Into an Aqueous-Based Resin

For the incorporation of metal copper-based nanoparticles into an aqueous-based resin, it should be homogenized and diluted by pouring the aqueous dispersion of copper nanoparticles in the mass proportions of 5.0% to 30.0%. Consequently, the other 95.0% to 70.0% of this mixture is composed of application resin.

The resin may be applied to the surface with brush, roller or, preferably, spray gun, forming a resin film containing metal copper-based nanoparticles incorporated as a biocide additive to promote antimicrobial and antiviral effect on the coated surface after drying the mixture.

### Example 14: Drying of Metallic Copper Base Nanostructures by Spray Drying

For the drying of the particles, 50 g of the suspension were separated, which were diluted by additional 50 g of water. The suspension, now 100 g, has been introduced to the Spray Dryer (BUCHI) equipment. The drying parameters were: 5.5 μm membrane, 105° C. inlet temperature, 54° C. outlet temperature, 100.0% piezoelectric membrane atomization, 120° C. nozzle temperature, 70 mbar pressure, 130 L/min gas flow.

The generated particulate powder was collected from the electrostatic compartment of the equipment.

### Example 15: Incorporation of the Metallic Copper Nanostructures Into an Application Polymer

For the incorporation of metal copper-based nanostructures into a polymer, the polymer should be dissolved in aqueous dispersion in the mass proportions of 1.0% to 10.0%, depending on the polymer, for example non-limiting, the PVA.

The mixture can be dried by simple heating or by mild heating by vacuum, forming a film and/or resin test body with metal copper-based nanoparticles incorporated in different proportions to promote antimicrobial and antiviral effects on the surface of the material after drying and modeling the product.

### REFERENCES

ADLHART, C., et al. Surface modifications for antimicrobial effects in the healthcare setting: a critical overview. Journal of Hospital Infection, v. 99, p. 239-249, 2018.

APPLEROT, G. et al. Understanding the Antibacterial Mechanism of CuO Nanoparticles: Revealing the Route of Induced Oxidative Stress. Small, v. 8, n. 21, p. 3326-3337, 2012.

ATKINS, P., JONES, L.. Princípios de química: questionando a vida moderna e o meio ambiente. 5. Ed. Porto Alegre: Bookman, 2012.

AZAM, A. et al. Antimicrobial activity of metal oxide nanoparticles against Gram-positive and Gram-negative bacteria: a comparative study. International Journal Of Nanomedicine, v. 7, p. 6003-6009, 2012.

BEYTH, N., et al. Alternative Antimicrobial Approach: Nano-Antimicrobial Materials. Evidence-Based Complementary and Alternative Medicine, 16 pages, Article ID 246012, 2015.

BRITISH PHARMACOPEIA COMMISSION. British Pharmacopeia. Ed. 4. London: Sationery Office, 2002.

BUCHI. Operation Manual Nano Spray Dryer B-90. Version B. ed. Flawil: BUCHI, 2009.

DEPNER, R. F. R. et al. O cobre como superfície de contato antimicrobiana e sua potencial aplicação na medicina veterinária. Veterinária e Zootecnia, v. 22, n. 4, p. 532-543, 2015.

FAZENDA, J. M. R., et al. Tintas e vernizes: Ciência e Tecnologia. 3rd Ed. São Paulo: Edgar Blucher, 2009.

PHAM, L. Q. et al. Copper nanoparticles incorporated with conducting polymer: Effects of Copper Concentration and Surfactants on the Stability and Conductivity. Journal of Colloid and Interface Science, v. 365, p. 103-109, 2012.

PRADEEP, T. Nano: The Essencials. McGraw-Hill, Chennai, 2007.

ROY, R., et al. Strategies for combating bacterial biofilms: A focus on anti-biofilm agents and their mechanisms of action. Virulence, v. 9, n. 1, p. 522-554, 2017.

SERGEEV, G. B. Nanochemistry. Oxford: Elsevier, 2006.

TAMAYO, L., et al. Copper-polymer nanocomposites: An excellent and cost-effective biocide for use on antibacterial surfaces. Materials Science and Engineering C, v. 69, p. 1391-1409, 2016.

TORTORA, G. J.; FUNKE, B. R.; CASE, C. L. Microbiologia, 10ª Ed. Porto Alegre: Artmed, 2012.

USMAN, M et al. Synthesis, characterization, and antimicrobial properties of copper nanoparticles. International Journal of Nanomedicine, p. 4467-4479, 2013.

VINCENT, M. et al. Contact killing and antimicrobial properties of copper. Journal Of Applied Microbiology, v. 124, n. 5, p. 1032-1046, 2017.

VINCENT, M.; HARTEMANN, P.; ENGELS-DEUTSCH, M. Antimicrobial applications of copper. International Journal Of Hygiene And Environmental Health, v. 219, n. 7, p. 585-591, 2016.

ZHONG, T. et al. Antimicrobial Properties of the Hybrid Copper Nanoparticles-Carboxymethyl Cellulose. Wood And Fiber Science, v. 45, n. 2, p. 215-222, 2013.

ZHONG, T. et al. Drying cellulose-based materials containing copper nanoparticles. Cellulose, v. 22, n. 4, p. 2665-2681, 2015.

1. A process for producing a copper nanoparticle hybrid antimicrobial and antiviral agent, comprising the synthesis of metal nanoparticles via a chemical route from an aqueous-soluble conjugate salt of the metal, characterized by comprising
a) by adding, into a reactor:
(i) a solution of metallic copper precursor in water with concentration ranging from about 0.1 mmol/L to about 20 mol/L;
(ii) a coating agent selected from a polysaccharide biopolymer or a cationic surfactant, in concentration ranging from about 0.1% to about 25.0% (m/m); and
(iii) a solution of oxidizing agent in water with a concentration between about 0.1 mmol/L and about 10.0 mol/L;
b) complete the reactor volume with water so as to fill half of the reactor volume, except for the reducing agent volume to be added;
c) seal the system, maintaining temperature control between about 0° C. and about 100° C.;
d) as an option, add inert gas into the reactor;
e) stir the mixture obtained in a) with speed between about 250 rpm and about 1500 rpm;
f) after stabilizing the temperature, add reducing agent solution at a constant flow rate of about 0.1 mL/hour and about 10.0 L/hour.

2. Process, according to claim 1, characterized in that the copper precursor can be selected from copper acetate, copper carbonate, copper chloride, copper hydroxide, copper iodide, copper nitrate, copper (I) oxide, copper (II) oxide, copper sulfate, copper (I) sulfide, copper (II) sulfide, and mixtures thereof.

3. Process, according to claim 1, characterized in that the coating agent is a polysaccharide biopolymer selected from the group consisting of chitosan, carboxymethyl cellulose and gum arabic, or mixtures thereof, or a cationic surfactant selected from the group consisting of cetylpyridinium chloride, ethoxylated sorbitan monolaurate 80 and cocoamidopropyl betaine, or mixtures thereof.

4. Process, according to claim 3, characterized in that the polysaccharide biopolymer is selected from about 0.1% to about 2.5% (w/w) chitosan dissolved in acetic acid solution in water at a concentration between about 0.1 and about 5.0 mol/L; or carboxymethyl cellulose dissolved in water in a ratio by weight between about 0.1% and about 10.0%; or acacia gum dissolved in water in a concentration between about 0.1% and about 25.0%, or mixtures thereof.

5. Process, according to claim 3, characterized in that the cationic surfactant is selected from cetylpyridinium chloride in deionized water in a mass ratio between about 0.05% and about 20.0%, or ethoxylated sorbitan monolaurate 80 dissolved in water in a ratio by weight between about 0.05% and about 20.0%, or coco amidopropylbetaine in water in a ratio by weight between about 0.05% and about 20.0%, or mixtures thereof.

6. Process, according to claim 1, characterized in that the reddish-brown copper metal-based nanostructures are dried or kept dispersed in the aqueous medium.

7. Process, according to claim 6, characterized in that the drying is performed by simple evaporation for about 6 to 12 hours in an oven at about 80° C. or for about 24 to 48 hours at room temperature, wherein the nanostructure dispersion is applied to a compatible resin or polymer on an aqueous basis.

8. Antimicrobial and antiviral agent hybrid of copper nanoparticles and active organic compounds, characterized by at least 90% of the product of copper metal-based nanostructures coated with the polysaccharide biopolymer having particle size below 560 nm.

9. Hybrid antimicrobial and antiviral agent of copper nanoparticles and active organic compounds, according to claim 8, characterized by being applied as an additive in resins, paints, papers, fabrics, wood, polymeric materials or dispersed in sanitizing products, such as: detergents, alcohol gels, disinfectants or fabric softeners, or in strategic environments requiring lower contamination rates, such as hospital, agricultural and veterinary areas, as well as public environments and public transportation interiors, agricultural and veterinary.

10. Use of a hybrid antimicrobial and antiviral agent of copper nanoparticles and active organic compounds, characterized for being biocidal or biostatic by preventing the growth and proliferation of the biological agent, being incorporated as an additive in resins, paints, papers, fabrics, wood, polymeric materials or dispersed in sanitizing products, such as: detergents, alcohol gel, disinfectants or fabric softeners, or be applied in strategic environments that need lower contamination rates, such as hospital, agricultural and veterinary areas, as well as public environments and public transportation interiors.

11. Use according to claim 10, characterized in that the microorganisms are selected from the Gram − group consisting of Escherichia coli and Pseudomonas aeruginosa and Gram + being Staphylococcus aureus and Streptococcus agalactiae, the yeast Candida albicans and the enveloped RNA virus, canine coronavirus.

12. Process, according to claim 2, characterized in that the reddish-brown copper metal-based nanostructures are dried or kept dispersed in the aqueous medium.

13. Process, according to claim 3, characterized in that the reddish-brown copper metal-based nanostructures are dried or kept dispersed in the aqueous medium.

14. Process, according to claim 4, characterized in that the reddish-brown copper metal-based nanostructures are dried or kept dispersed in the aqueous medium.

15. Process, according to claim 5, characterized in that the reddish-brown copper metal-based nanostructures are dried or kept dispersed in the aqueous medium.
